(19) United States
(12) Patent Application Publication
(10) Pub. No.: US 2010/0050958 A1
(43) Pub. Date: Mar. 4, 2010

(54) Animal cooling vest

(76) Inventors: Susan M. Jackson, Powhatan, VA (US); Sharon M. Munyak, Powhatan, VA (US)

Correspondence Address: Susan M. Jackson, 3535 Huguenot Trail, Powhatan, VA, 23139, US

(21) Appl. No.: 12/231,584

(22) Filed: Sep. 4, 2008

(51) Int. Cl. A01K 13/00

(52) U.S. Cl. 119/850

(57) ABSTRACT

The present invention is a water-absorbent animal cooling vest made with an inner core of woven, hydrophilic/hydrophobic polymer embedded fabrics (PEF) enclosed inside two exterior (a wicking fabric inside to the body and a breathable fabric outside to the air) fabric shells attached to the animal by criss-crossing two double-ended, elastic and adjustable hook straps over the rear of the animal's neck, which straps are then attached to sewn-on loops on the upper and lower parts of the vest. The vest is soaked in approximately 3-16 ounces of water (depending on the size of the vest and the size of the animal for which is to be used) for 3-15 minutes (again depending on size of vest) before use, thus allowing the inner core to absorb the water. This process begins the vest's evaporative process. The internal core fibers of the vest absorb many times its weight in water. Excess water is wrung out of the vest prior to installation. The cooling evaporative process lasts for several hours based on ambient temperature, activity and level of exertion of the animal. The purpose of the vest is to promote absorption of moisture and body heat from the animal into the vest and enhance the natural evaporative cooling process to reduce body temperature and heat stress, which can lead to heat stroke, a significant cause of death for equines and other four-legged domestic animals. The animal cooling vest may be reactivated by simply re-immersing in water for a short period and reinstalling. The animal cooling vest may be machine washed and dried and is re-useable. Due to the flexible characteristics of the fabric materials comprising the vest and the method of strapping the vest to the animal, the vest shapes closely to the animal's body for maximum direct contact to the critical chest area of the body while allowing complete freedom of movement.

### CROSS REFERENCE TO RELATED APPLICATIONS

This patent claims priority to U.S. Provisional Patent Application No. 60/956,170, filed Aug. 16, 2007, which is incorporated by reference into this Utility Patent Application.

For animals that do not sweat, such as dogs and cats, the animal cooling vest functions to absorb body heat from the chest and lower abdominal area, again where the critical heart and lungs are located, to help reduce body temperature in this critical area of the body and reduce the likelihood of the animal experiencing heat stress.

This invention relates generally to an animal cooling vest that incorporates enhanced natural evaporative cooling technology to promote animal health and well-being by preventing and/or relieving animal heat stress that can and sometimes does lead to heat stroke. The animal cooling vest is made of an hydrophilic/hydrophobic polymer embedded fiber core enclosed by an inside (adjacent to the body) wicking fabric and an exterior breathable fabric designed to enhance the natural evaporation process of the animal's body. The animal cooling vest is immersed in water for from 3-15 minutes, depending on size of vest. Excess water is then wrung out, prior to installation. The animal cooling vest is shaped and sized to the chest and lower abdominal area of the animal for which it is intended, is attached by means of two adjustable straps with a hooking mechanism at each end, which straps are criss-crossed behind the animal's neck, over the shoulders, and down each side, from the upper to the lower portion of the cooling vest, where the straps are fastened to loops sewn onto the vest. The criss-cross method of attachment, together with the adjustable straps, hold the cooling vest in place and in close proximity to the animal's chest and just below the abdominal area and behind the front legs, where the animal's critical organs (heart and lungs) are located. For animals that do not sweat, such as dogs and cats, or animals with a condition known as anhydrosis (failure of sweat glands to function normally), the animal cooling vest functions to absorb body heat from the chest and lower abdominal area, again where the critical heart and lungs are located, to help reduce body temperature in this critical area of the body and reduce the likelihood of the animal experiencing heat stress.

### STATEMENT REGARDING FEDERALLY SPONSORED RESEARCH OR DEVELOPMENT

This invention was not federally sponsored.

### BACKGROUND OF INVENTION

1. Field of Invention

The invention relates generally to use of an animal cooling vest that incorporates enhanced natural evaporative cooling technology to promote animal health and well-being by relieving animal heat stress that can and sometimes does lead to heat stroke. The animal cooling vest is made from core of a polymer embedded hydrophilic/hydrophobic fibers enclosed by an inside (adjacent to the body) wicking fabric and an exterior breathable fabric designed to enhance the natural evaporation process of the animal's body. For animals that do not sweat, such as dogs and cats, or those animals with anhydrosis, the animal cooling vest functions to absorb body heat from the chest and lower abdominal area, again where the critical heart and lungs are located, to help reduce body temperature in this critical area of the body and reduce the likelihood of the animal experiencing heat stress.

2. Description of Related Art

Evaporation is a naturally occurring phenomenon whereby moisture is absorbed into the atmosphere. This process requires sufficient heat to convert the moisture into vapor. In the case of mammals, most produce moisture known as sweat. The body and the air provides the heat needed to evaporate the sweat into the air. This process reduces body surface temperature and also makes the body “feel” cooler. An example for humans is sunbathing. As the temperature rises, the body “feels” hot. Sweat is produced and the body's temperature is reduced. Often, a quick fix is immersion in the local pool or lake. This quick body surface temperature reduction results in reduction of overall body temperature and an immediate feeling of heat relief. However, going into 40° F. water will result in physiological shock and result in death in a short time. 110° F. water will offer no relief and actually increase body temperature. Therefore, the best approach to preventing heat stress is to provide a method to enhance the natural evaporative cooling process before heat stress occurs.

Cooling an animal's body by using ice is a method of reducing body temperature and potential heat stress. However, this requires ice to be available, which is not always the case. Ice, which causes rapid cooling, may also cause shock to the body. The same is the case for direct application to the animal's body of well or tap water, which may or may not be readily available but is often too cool to use except in extreme cases of heat stress.

Domestic animals experience heat exhaustion and stress similar to humans, for whom cooling vests of one type or another have been available for many years. In the case of all animals, human or otherwise, heat stress or heat stroke can lead to serious illness or even death. Every animal reacts differently to the effects of heat stress, but as temperatures rise above 85° F., heat stress becomes a significant factor in an animal's health. In many geographic areas temperatures above 85° F. are a regular daily occurrence for many months of the year. Frequently, temperatures rise in some geographic areas well over 100° F. for days and weeks at a time with little or no relief even at night. Since many animals do not have the luxury of air conditioning or a pool in their everyday habitat, reducing the risk of and preventing heat stress, which can and does often lead to heat stroke, will promote animal health. A reduction in body temperature of even an few degrees can mean the difference between life and serious illness or death.

Mammals generally have a built-in autonomic body mechanism to naturally reduce body temperature when ambient temperature exceeds that certain point at which the body's temperature begins to rise above its normal state. This process is sweating. Sweat is produced by the body, excreted to the skin and evaporated into the air. This process reduces skin and body temperature naturally. However, in the event of over exertion or excessive external heat, such as when the outside temperature exceeds 85° F., the point at which many animals begin to become uncomfortable and susceptible to heat stress, the body needs external assistance to enhance the evaporative process to prevent, or reduce the severity of, heat stress. For most humans going into an air conditioned structure solves the problem. For many animals this is not readily available or practical.

On the other hand, not all mammals sweat. Because dogs and cats do not sweat, and some animal's suffer from anhydrosis (failure of the sweat glands to function normally), their respiratory and circulatory systems play an even more significant part in the regulation of body temperature. For dogs and cats the natural cooling method is breathing. Heavy breathing in dogs, known as panting, is a likely sign of an increase in body temperature. Breathing allows the animal to expel heated waste gases from within the lungs. Heated waste gases are expelled and replaced with air, generally of a lower temperature than the expelled gases. By cooling the lungs, the animal does not have to work as hard to reduce body temperature through excessively heavy breathing. With all animals, cooling the heart also has the effect of cooling the blood stream. Since blood flows throughout the body, cooler blood reduces overall body temperature, thus contributing to reduced likelihood of an animal suffering from heat stress.

The process of evaporative cooling is a naturally occurring phenomenon. Over the years numerous patents have been issued for various methods of body temperature reduction through the use of cooling vests designed for humans. In Steele, et al, U.S. Pat. No. 5,305,471, Apr. 26, 1994, a human vest covering the torso with multiple pockets designed to accept cooling packets was taught. In Kung, U.S. Pat. No. 5,524,293, Jun. 11, 1996, the method involved a vest for humans with a flexible vessel filled with water. Silva, U.S. Pat. No. 5,755,110, May 26, 1998, presented a human vest with elongated partitions “containing beads of polyacrylamide material that absorb liquid, such as water.” Each of these inventions involved relatively complex methods of cooling through the use of vests designed for the human wearer thereof.

In Bumbarger, U.S. Pat. No. 6,371,977, Apr. 15, 2002 and related patents, a patent was issued for a garment material that incorporated specially treated, light-weight fibers that are woven into a thin, flat fabric that absorb water to promote evaporative cooling and acts as the core of an overall flexible garment material with outer and inner fabric shells. The inner core absorbs moisture through the inside (to the body) wicking fabric shell and evaporates that moisture through the breathable outer shell. The result is a three-layerd fabric that can be sewn into any number of garments, with the patent specifically referencing vests to be used by humans.

Most recently, Gordon submitted U.S. Patent Application number 20080040839, filed Jun. 21, 2007, wherein a request was made for a utility patent for cooling garments including: vests for humans, a blanket for animals, a head garment for animals, leg wraps for humans and animals, and a neck wrap. The Gordon Application presents significant information on the technical specifications of the evaporative cooling material to be used by his invention. However, Bumbarger taught (see above), a polymer embedded fiber (PEF) material clearly specifying its use in making human cooling and protective vests. Gordon (U.S. Patent Application number 20080040839) also specifically references (see (0027) Background of Invention under the referenced Application) several companies presently marketing water absorbent evaporative cooling vests and offers only that his invention is a more efficient evaporative material.

The present animal cooling vest invention uses an hydrophilic/hydrophobic polymer embedded fabrics (PEFs) core with interior and exterior shells designed to promote evaporative cooling for the wearer, specifically four-legged domestic animals, for the purpose of reducing body heat in those animals, particularly in the critical heart and lung area of the chest, and the potentially life threatening heat stress that can result from elevated body/internal organ temperature. The present animal cooling vest invention is clearly a different approach to animal cooling than the animal cooling blanket, etc. offered by Gordon, as well as the other referenced prior applications and manufacturers.

By using this present invention, which enhances the natural evaporative cooling process and is intended for use before as well as after heat stress may become apparent, the owner of a domestic animal can reduce the likelihood of heat stress as well as the effects of existing heat stress, thus enhancing the animal's life, preventing excessive veterinary expenses related to resolving the effects of heat stress or stroke, and potentially saving the life of their animal.

Therefore, the most reasonable approach to animal heat stress is not only a preventative measure such as the present invention, but one that can easily be used after heat stress exists. The present invention uses a minimal water source that is easily portable while traveling or at any location where an animal is located. The animal cooling vest may be made in any size. It is machine washable; machine dryable, and can be used over and over. No previous application for an animal cooling vest using evaporation cooling technology has been taught.

### SUMMARY OF THE INVENTION

Accordingly, it is an object of the present animal cooling vest invention to provide a method to prevent animal heat stress; or in the case of an animal already having experienced heat stress, reducing the severity thereof so as to reduce the potential for onset of heat stroke.

Another object of the invention is reduce or minimize the effects of heat stress after exercise, while traveling or during medical procedures, both of which frequently cause physical stress that often results in a significant rise in an animal's body temperature. As with any mammal, humans included, a rise in body temperature of even a few degrees ° F., can become a serious health problem and must be dealt with to prevent even more serious illness.

In accordance with the present invention, the animal cooling vest incorporates evaporative cooling technology in a way that has not previously been afforded domestic animals. There have been cooling vests for animals that require refrigeration, some with ice packs fit into exterior pockets, etc., but none that simply require the use of water absorbent polymer embedded fabrics that enhance the natural cooling process, such as provided in the present invention. There are also cooling blankets, but these do not provide cooling to the part of an animal's body (the chest and front lower abdomen) that houses the animal's critical internal organs that are most susceptible to heat stress and which organs operate to reduce body temperature. It is further offered that by reducing the temperature of an animal's chest area, which houses the lungs and heart, the result is a reduction in the temperature of the blood that circulates throughout the animal's body, thus reducing overall body temperature.

In accordance with the present invention, use of the animal cooling vest will augment natural evaporative cooling and reduce body temperature of the animal, thereby reducing the potential for heat stress and heat related animal health issues.

### BRIEF DESCRIPTION OF THE DIAGRAMS

Other objects, features and advantages of the present invention will become apparent upon reference to the following description of preferred embodiments and to the drawings, wherein corresponding reference characters (numerals) indicate corresponding parts throughout the several views of the drawings and wherein:

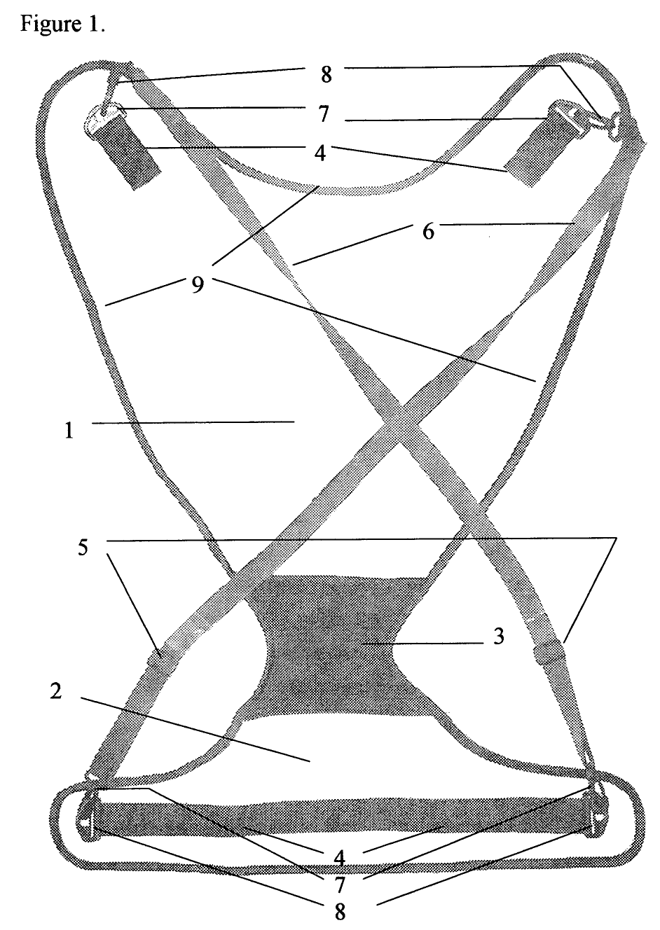

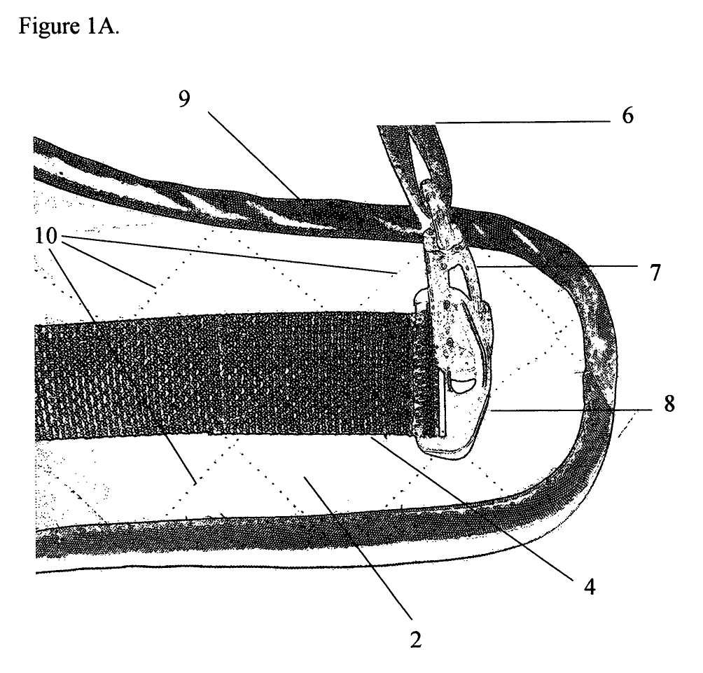

FIG. 1 is front view of the animal cooling vest with the adjustable straps attached across the front of the vest. These straps, when installed on the animal, will generally not be visible when looking head on to the animal since they are intended to be crisscrossed over the animal's shoulders and attached underneath the animal's abdomen.

FIG. 1A is a view of a representative animal, in this case a horse, with the animal cooling vest properly affixed using the adjustable straps.

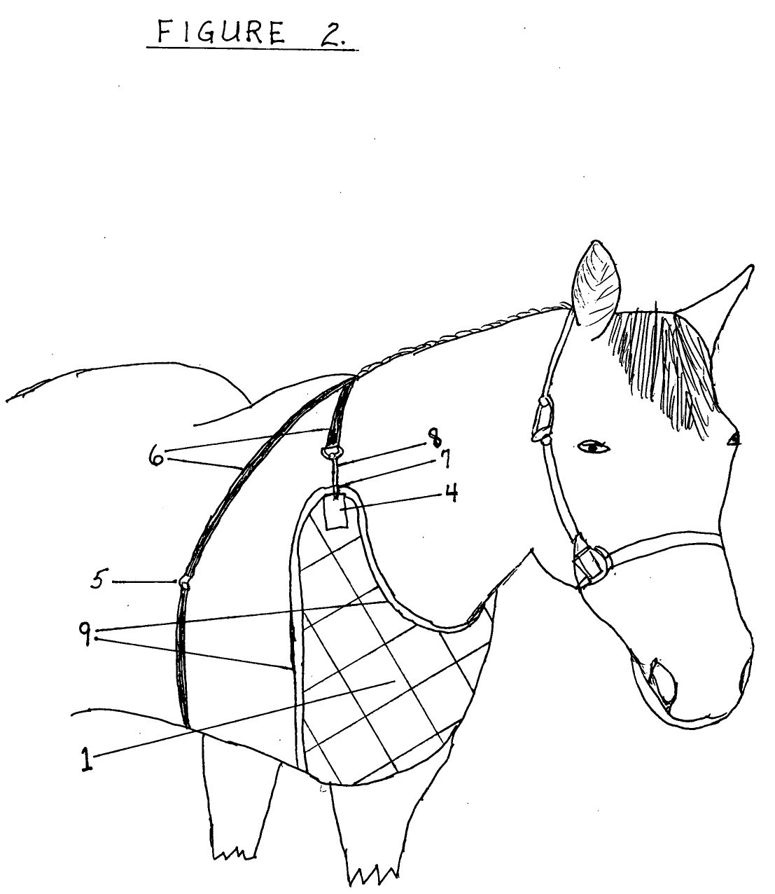

FIG. 2 is a close up view of one of the four adjustable strap attachment component systems. The strap attachment system is simple, durable and allows a single individual to install the animal cooling vest safely.

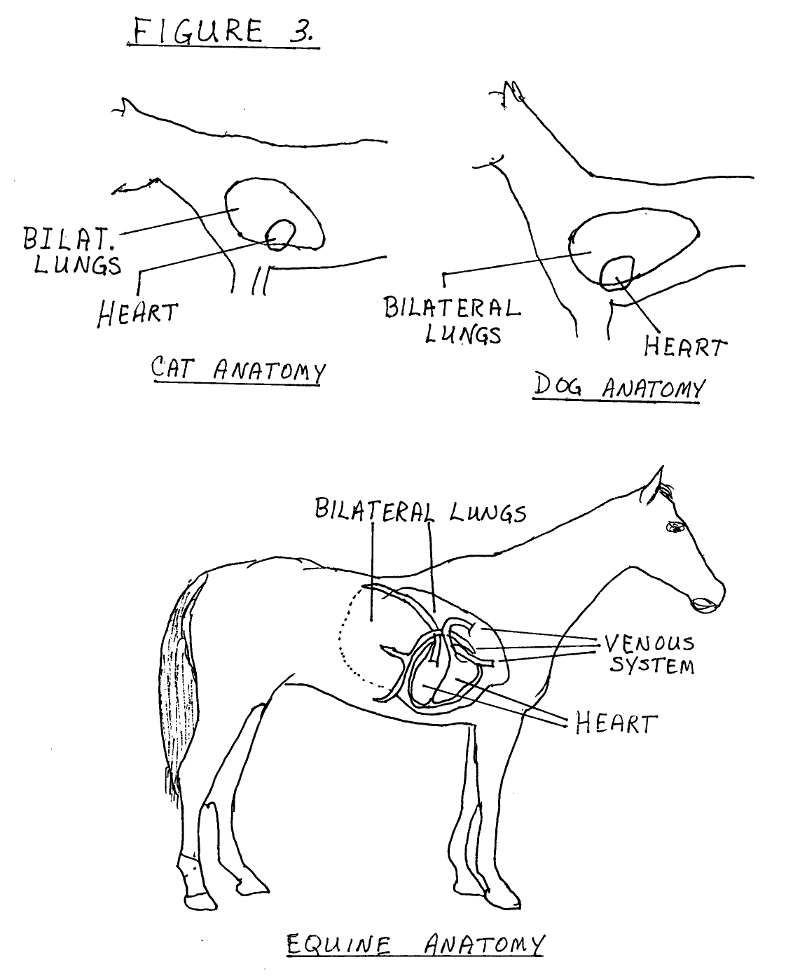

FIG. 3 shows the anatomical location of the critical organs (heart and lungs) of a representative sample of potential users of the animal cooling vest. These organs are located in the chest cavity directly above the abdominal area located immediately behind the front legs of the animals.

### DETAILED DESCRIPTION OF THE INVENTION

Referring to the drawings, specifically FIG. 1, the detail of the invention is herein described. FIG. 1, numerals 1 and 2, identify the hydrophilic/hydrophobic, multi-layered, polymer embedded fabric that is used to make the vest. FIG. 1, numeral 1 shows the upper portion and numeral 2 shows the lower portion of the vest, respectively. These are stitched together with a stretchable fabric FIG. 1, numeral 3, in between, such that the stretch material fits between the animal's two front legs and allows free body movement while keeping the vest in close contact with the body. For FIGS. 1, 1A and 2, the numerals on each correspond to identical parts on each of the other Figures.

FIG. 1, numeral 8, shows two upper (one on either side of the vest) and two lower (at opposite ends of a single piece of sewn-on material, FIG. 1, numeral 4) loops for attaching the adjustable, elastic straps FIG. 1, numeral 6. FIG. 1, numeral 4 shows the fabric sewn onto the vest that hold the loops, FIG. 1, numeral 8, used for attaching the adjustable straps, FIG. 1, numeral 6. FIG. 1, numeral 6, shows the elastic, adjustable straps that are criss-crossed over the rear area of the animal's neck. Each of these straps have a simple hooking mechanism, FIG. 1, numeral 7, at either end that attaches to the loops, FIG. 1, numeral 8, to keep the vest in place on the animal's chest and immediately behind the front legs. Due to the elasticity of the adjustable straps, the animal cooling vest maintains close contact with the animal's body. FIG. 1, numeral 5 shows the simple adjustment mechanism used to tighten or loosen the length of each strap for maintaining close contact with the animal's body. Because the straps are of an elastic material, constriction of the animal's movement does not occur. The animal cooling vest is finished by sewing a fabric border, FIG. 1, numeral 9, completely around the edge of the vest. Each of the numerals on the several drawings refer to the identical part on the other drawings of the vest.

With reference to FIG. 1A, this drawing is a blow up illustration of the strap hook and loop connections at one side of the lower section of the vest as attached on the animal's underside. There are four such connections, one at each of the four corners of the vest. The multi-layered raw fabric material from which the animal cooling vest is made, is quilted during manufacture of the vest. FIG. 1A, numeral 10, illustrates a sample quilting pattern. Quilting is done to prevent the inner PEF core from shifting or settling internal to the exterior fabrics comprising the vest.

FIG. 2, numeral 1, illustrates the correct method of wearing the animal cooling vest covering an animal's chest, and identifies the underside of the animal just behind its front legs, FIG. 1, numerals 2, where the lower section of the vest is affixed. The two adjustable straps, FIGS. 1 and 2, numeral 6, are criss-crossed from the lower section of the vest, FIG. 1, numeral 2, over the rear of the animal's neck and attached to the loops FIG. 2, numeral 8, on the opposite lower side of the vest, thus holding the vest in place to allow the animal to perform all normal daily activities.

FIG. 3 illustrates the internal organs of a representative, though not exhaustive, sample of the type animals for which the animal cooling vest may be used. The representative sample is not intended to limit the use of the animal cooling vest to these animals alone. The purpose of the illustrations is to show the relative location of a four-legged animal's critical internal organs (heart and lungs) in the chest cavity and directly behind and above the animal's front legs, the physical area of the animal that is intended to be covered by the present invention.

Referring to FIG. 3, the animal's critical organs (heart and lungs) that are most susceptible to heat stress and heat stroke, and which play a significant role in reducing body temperature through blood circulation and expelled waste gases, are located in the chest cavity and immediately above and behind the animal's front legs. In order to reduce the likelihood of heat stress or minimize the effects after heat stress has set in, the herein presented animal cooling vest, when immersed by water, affixed to the animal as specified and used before heat stress is evident, will assist the animal in reducing its body temperature through enhancement of the natural evaporative cooling process without the undesired effects of rapid cooling (ice packs, etc.) that can cause shock to an animal's system and requires careful monitoring during the cooling process, which process may take several hours or more before satisfactory results can be achieved to bring the animal to a safe, healthy state.

The animal cooling vest that is the subject of the present design invention, is specifically designed to attach to an animal's body in such a way as to come in direct contact with the animal's chest area and that area immediately behind and above the animal's front legs. The method of attachment, criss-crossing adjustable elastic hook straps, is the preferred method of attaching the animal cooling vest to insure maximum body contact at the intended location of the animal's body without causing restriction of the animal's normal movement.

What is claimed as new and desired to be secured by Letters Patent of the United States is:

1. A flexible animal cooling vest comprising an inner woven core made of a polymer embedded fabric (PEF) with hydrophylic/hydrophobic properties, enclosed by two external shells, and designed to cover the chest and front-lower abdominal area of a four-legged animal attached so as to adhere closely to the animal's body for the purpose of enhancing the natural evaporative cooling process, thereby reducing body temperature and aid in the prevention of heat stress.

2. A flexible animal cooling vest of claim 1 whose three layers include a wicking fabric (worn closest to the body), an hydrophilic/hydrophobic PEF inner core and an exterior breathable fabric quilted together for maintaining internal stability and worn as described herein and whose properties, when immersed in from 3 to 16 ounces of water for a period of from 3 to 15 minutes (depending on size of the vest), enhance the natural evaporation cooling process to reduce both surface and body temperature of the animal through evaporation of sweat, the body's natural method of reducing body temperature.

3. A flexible animal cooling vest of claim 2 whose evaporative cooling properties function similarly for animals that do not sweat, such as dogs and cats, whereby heat is absorbed from the animal's body to evaporate the water absorbed by the vest's inner core, thereby reducing body heat and temperature.

4. A flexible animal cooling vest of claim 1 that is approximately ⅛″ thick, both dry and after water immersion, that may be manufactured in any size or shape to fit the animal for which it is intended.

5. A flexible animal cooling vest of claims 1 and 2 whose inner core absorbs many time its weight in water, with the finished vest weighing a total of from 5 to 28 ounces, the inner core of which weighs less than one (1) ounce (for small canine/feline vests) and up to about four (4) ounces (for large equines) dry, plus the weight of from 3 to 16 ounces (approximately 1 ounce of weight per ounce of water) of water depending on the size of the vest and the animal for which it is intended. The additional weight of the vest is in the strap and hook attachments. For a 150 pound human this is the equivalent of adding approximately one and one-half pounds of additional weight in the form of a closely fitting vest, a relatively insignificant weight increase.

6. A flexible animal cooling vest of claim 1 that is attached to the animal by means of two elastic, adjustable fabric straps with light-weight hooks at either end that are criss-crossed over the rear of the animal's neck and then attached to four loops sewn onto each of the four corners of the vest (two upper and two lower loops.

7. A flexible animal cooling vest whose method of enhancing the natural evaporative cooling process of the chest and lower abdominal area of four-legged domestic animals such as equines, felines and canines, such that the body area in contact with the animal cooling vest (animal's chest) houses the animal's critical organs, the heart and lungs, which organs are the most susceptible to heat stress due to excessive ambient temperature or body heat generated by exercise or other stressful situations such as, but not limited to, transporting or during medical procedures, and which organs play a significant role in reducing body temperature through blood circulation and expending of waste gases, respectively.
